(19) United States
(12) Patent Application Publication
(10) Pub. No.: US 2010/0194915 A1
(43) Pub. Date: Aug. 5, 2010

(54) METHOD AND APPARATUS FOR PROCESSING COLOR VALUES PROVIDED BY A CAMERA SENSOR

(76) Inventors: Peter Bakker, Waardenburg (NL); Johan Schirris, Veldhoven (NL)

Correspondence Address: MALCOLM J ROMANO, 116 S CITRUS AVE, LOS ANGELES, CA, 90036, US

(21) Appl. No.: 12/678,197

(22) PCT Filed: Jan. 9, 2008
(86) PCT No.: PCT/EP08/50162

§ 371 Date: Mar. 15, 2010

(51) Int. Cl. H04N 9/73

(52) U.S. Cl. 348/223.1; 348/E09.037

(57) ABSTRACT

In a method suitable for processing colour values provided by a camera sensor comprising pixels of different colours, values of a first colour at positions of pixels of a second and a third colour are interpolated (102) based on an averaging using at least one control value.

The invention relates to a method and an apparatus suitable for processing colour values provided by a camera sensor comprising pixels of different colours, a corresponding computer program and a corresponding computer program product.

### PRIOR ART

Digital cameras may use a RGB (Red, Green, Blue) or Bayer colour filter array on the camera sensor. Such an array provides only one colour per pixel, i.e. red, green or blue. Thus, the image has to be reconstructed to three colours per pixel. This process is called reconstruction or separation as colours are separated from luminance.

RGB separators are well known from literature, for example from J. E. Adams, “Interactions between color plane interpolation and other image processing functions in electronic photography”, Proc. SPIE Cameras and Systems for Electronic Photography and Scientific Imaging, vol. 2416, 1995, from J. E. Adams, “Designs of practical color filter array interpolation algorithms for digital cameras”, Proc. SPI Real Time Imaging II, vol. 3028, 1997, from R. Kimmel, “Demosaicing: Image reconstruction from color CCD samples”, IEEE Trans. Image Proc., vol. 8, no. 9, pp. 1221-1229, September 1999, or from Chung-Yen Su, Chi-Ming Lin and Yi-Shien Lin: “Effective False Color Suppression of Demosaicing Using Direction Inversion and Bidirectional Signal Correlation”; National Taiwan Normal University 162, Section 1, Heping East Road, Taipei, Taiwan; ICIP 2007 conference.

Known RGB separators for still picture cameras have an excellent resolution performance up to the theoretical maximum, the Nyquist frequency.

However, RGB separators have the disadvantage that small details and noise in the image near the maximum frequency have a preference to produce mainly horizontal and vertical structures, also named “brick” artefact. Specifically on diagonal input material and with temporal noise these structures can easily switch over from horizontal to vertical and vice versa.

On still images, without temporal noise, this disturbance is hardly noticeable but on motion video cameras, thus with temporal noise, this artefact can become clearly visible especially on images where this artefact contrasts with expectations of the viewer like motion in water surfaces and faces.

U.S. Pat. No. 5,373,322 describes a method for adaptively interpolating a full color image utilizing chrominance gradients in order to reduce color edge artefacts and to improve image sharpness.

U.S. Pat. No. 5,629,734 is directed to an adaptive color plan interpolation in a single sensor color electronic camera.

U.S. Pat. No. 4,724,395 describes a median filter for reconstructing missing color samples.

It is an object of the invention to provide a method suitable for processing colour values provided by a camera sensor, further an apparatus using this method and further a corresponding computer program and a computer program product, according to the independent claims. Advantageous embodiments are defined in the dependent claims.

### ADVANTAGES OF THE INVENTION

The invention offers a method to reduce “brick” artefact in a dynamic way. In particular the inventive approach allows brick artefact reduction in RGB separation for motion video. A number of controls may be set depending on the application. For instance a camera with a still mode and a motion video mode may have mode optimised separator settings for resolution versus artefacts.

According to an embodiment a method is provided which is suitable for processing colour values provided by a camera sensor comprising pixels of different colours, wherein the method is characterized in that values of a first colour at positions of pixels of a second and a third colour are interpolated based on an averaging using at least one control value. The first colour may be green, the second colour may be red and the third colour may be blue.

The at least one control value may comprise a fraction and/or a range control value. This allows reducing artefacts.

Further, the method may comprise a still mode and a motion mode, wherein the values of the first colour are interpolated based on the averaging in the motion mode and wherein different values of the first colour are interpolated without the averaging in the still mode. This allows mode optimised separator settings for resolution versus artefact.

The values of the first colour may be interpolated based on the equations

$$green\_new = [ \begin{matrix}\begin{matrix}v\_sum + h\_sum + \\ h\_hp + v\_hp\end{matrix} & if maxdif \geq threshold \\ green\_old & otherwise\end{matrix} ]$$

$$maxdif = fraction\_g \cdot ( hordif + verdif ) + range\_g$$

$$threshold = \vert hordif - verdif \vert$$

$$h\_hp = ( 2 S [ l , px ] - S [ l , px - 2 ] - S [ l , px + 2 ] ) / 2$$

$$h\_sum = ( S [ l , px - 1 ] + S [ l , px + 1 ] ) / 2$$

$$h\_dif = ( S [ l , px - 1 ] - S [ l , px + 1 ] ) / 2$$

$$v\_hp = ( 2 S [ l , px ] - S [ l - 2 , px ] - S [ l + 2 , px ] ) / 2$$

$$v\_sum = ( S [ l - 1 , px ] + S [ l + 1 , px ] ) / 2$$

$$v\_dif = ( S [ l - 1 , px ] - S [ l + 1 , px ] ) / 2$$

wherein

green_new: value of the first colour

fraction_g: fraction control

range_g: range control

S[a,b]: value of a pixel at position [a,b]

S[l,px]: value of a center pixel.

These equations may be added to known separation methods or replace equations of known separation methods.

Further, the different values of the first colour may be interpolated in still mode based on the equations

$$green\_old = [ \begin{matrix}h\_sum + h\_hp & if verdif > hordif \\ v\_sum + v\_hp & otherwise\end{matrix} ]$$

$$hordif = \vert h\_hp \vert + \vert h\_dif \vert$$

$$verdif = \vert v\_hp \vert + \vert v\_dif \vert$$

$$h\_hp = ( 2 S [ l , px ] - S [ l , px - 2 ] - S [ l , px + 2 ] ) / 2$$

$$h\_sum = ( S [ l , px - 1 ] + S [ l , px + 1 ] ) / 2$$

$$h\_dif = ( S [ l , px - 1 ] - S [ l , px + 1 ] ) / 2$$

$$v\_hp = ( 2 S [ l , px ] - S [ l - 2 , px ] - S [ l + 2 , px ] ) / 2$$

$$v\_sum = ( S [ l - 1 , px ] + S [ l + 1 , px ] ) / 2$$

$$v\_dif = ( S [ l - 1 , px ] - S [ l + 1 , px ] ) / 2$$

wherein

green_old: different value of the first colour

S[a,b]: value of a pixel at position [a,b]

S[l,px]:value of a center pixel

According to a further embodiment of the inventive method, values of the second and third colour at a position of a pixel of the first colour may be obtained by a horizontal or vertical interpolation using the values of the first colour.

Further, values of the second colour at positions of pixels of the third colour and values of the third colour at positions of pixels of the second colour may be interpolated based on the averaging. This allows determining all missing values of the first, second and third colour.

Correct values of the first, second and third colour may be selected from interpolated values and from values provided by the camera sensor. The correct values may be provided by an output of the method and used for creating an image. By selecting the correct values, artefacts within the image may be reduced.

An inventive apparatus performs all steps of the inventive method.

An inventive computer program comprising program code means is configured to perform all steps of the inventive method, when the computer program is executed on a computer or a corresponding processing unit, in particular on an inventive apparatus.

An inventive computer program product comprising program code means stored on a computer readable data carrier is provided for performing the inventive method, when the computer program is executed on a computer or a corresponding processing unit, in particular on an inventive apparatus.

Further advantages and embodiments of the invention will become apparent from the description and the enclosed figures.

It should be noted that the previously mentioned features and the features to be elucidated in the following are usable not only in the respectively indicated combination, but also in further combinations or taken alone, without departing from the scope of the present invention.

In the drawings:

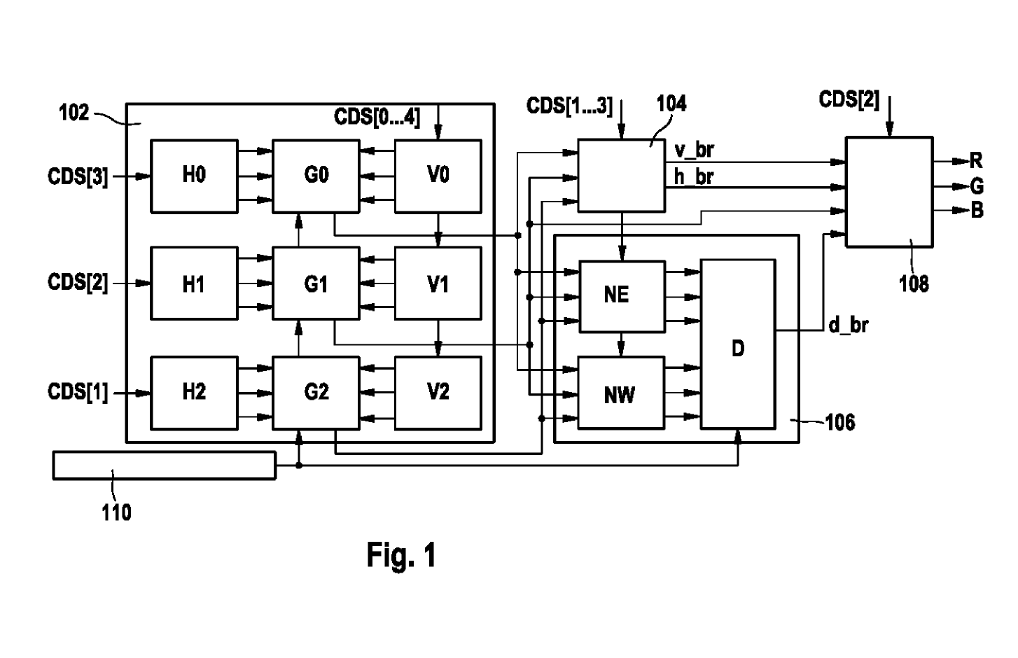

FIG. 1 shows a block diagram of a separator according to an embodiment of the invention;

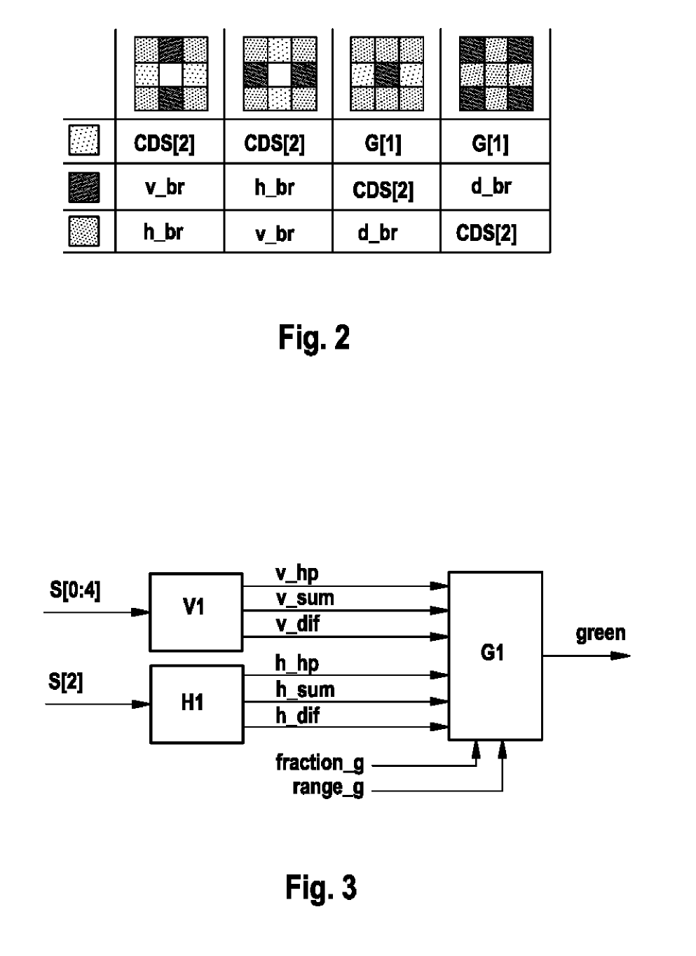

FIG. 2 shows a graphic table describing a selector function according to an embodiment of the invention;

FIG. 3 shows a green interpolation according to an embodiment of the invention;

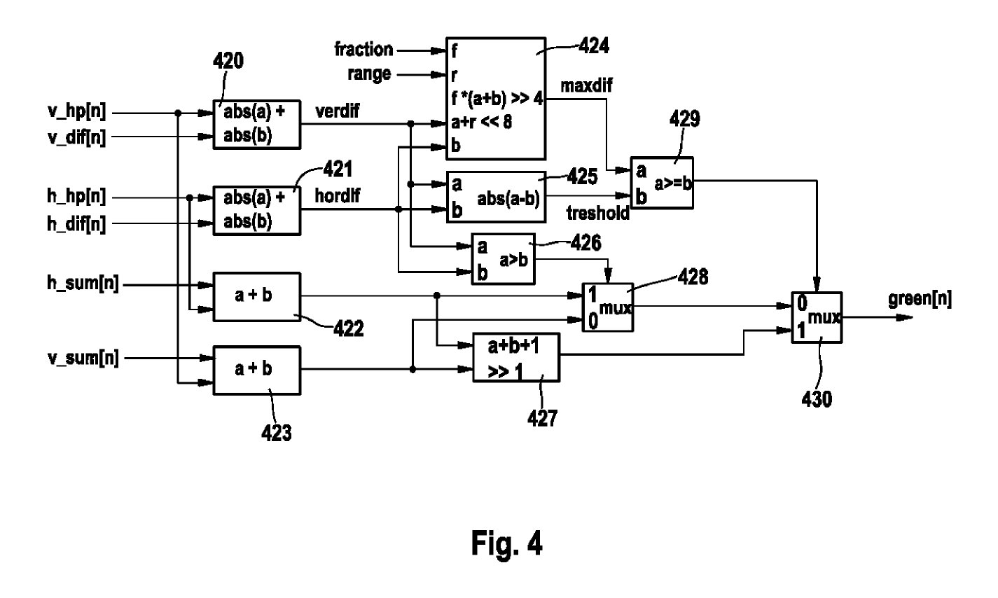

FIG. 4 shows a block diagram for interpolating green pixels according to an embodiment of the invention;

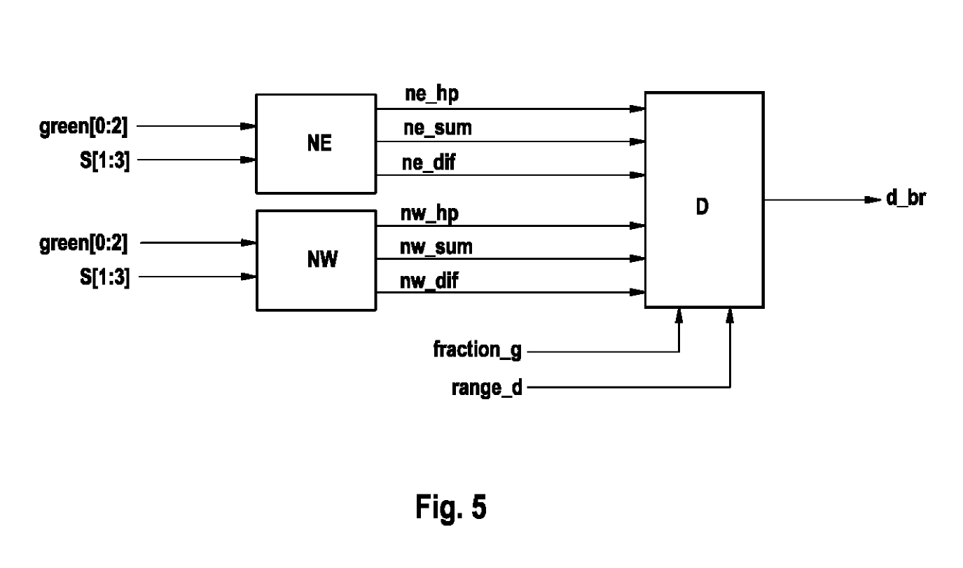

FIG. 5 shows a diagonal interpolator according to an embodiment of the invention;

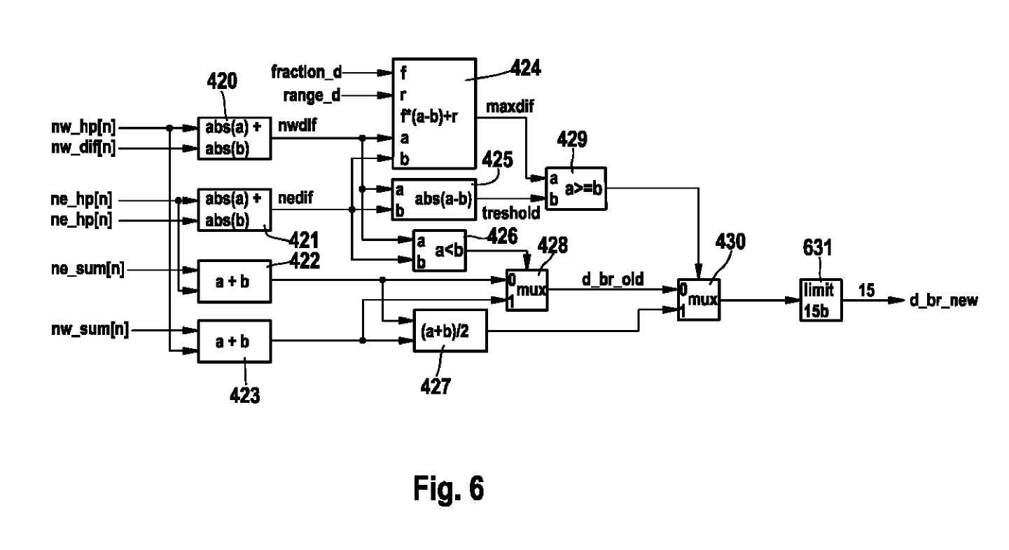

FIG. 6 shows a block diagram of a further interpolator according to an embodiment of the invention; and

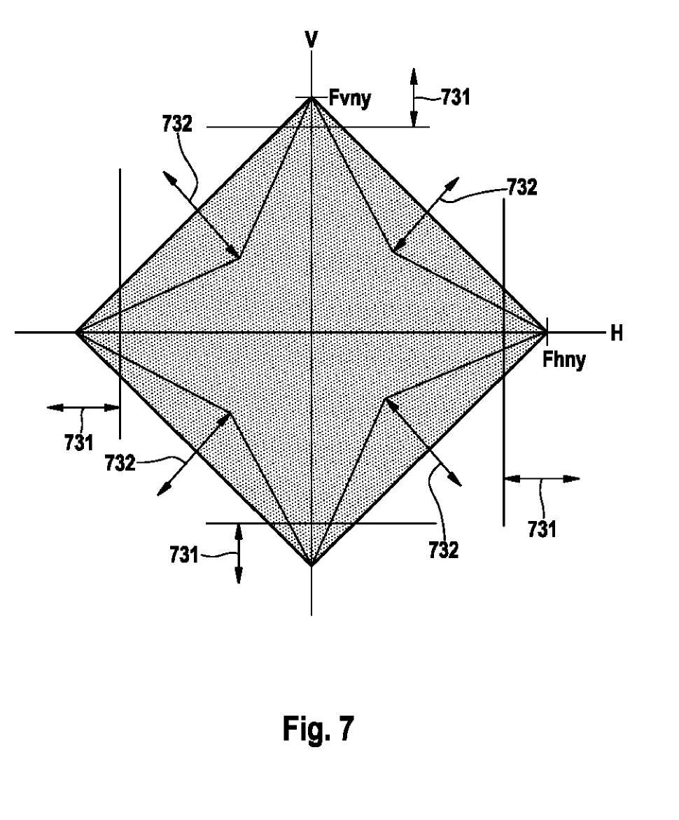

FIG. 7 shows a 2D spectrum of an output of a separator according to an embodiment of the invention.

FIG. 1 shows a block diagram of a RGB separator according to an embodiment of the invention. The separator may be based on a RGB bayer separator to which further circuitry is added. The RGB separator may be used in connection with a digital camera which uses a colour filter array and subsequent interpolation strategy to produce full-colour images. Thus, the RGB separator may be used to process input signals provided by a digital camera sensor in order to provide output signals which allow creating a colour image. The separator is able to reach a horizontal resolution equal to the Nyquist frequency.

According to this embodiment, the RGB separator comprises a green interpolation block 102, a horizontal/vertical interpolation block 104, a diagonal interpolation block 106, a selector 108 and a fraction/range control block 110.

The green interpolation block 102 comprises blocks H0, G0, V0, H1, G1, V1, H2, G2, V and is configured to receive signals CDS[0 . . . 4], comprising the following 5 input signals, CDS[0], CDS[1], CDS[2], CDS[3], and CDS[4]. The signals CDS[0 . . . 4] may be provided by a digital camera sensor. Further the green interpolation block 102 is configured to receive a signal from the fraction/range control block 110. The green interpolation block 102 is configured to output signals to the horizontal/vertical interpolation block 104, the diagonal interpolation block 106 and the selector 108.

In the green interpolation block 102 “H” indicates horizontal, “V” indicates vertical and “G” indicates green. The green interpolation block 102 is configured to process three video lines 0, 1, 2, simultaneously. Thus, the numbers in block 102 indicate the input video line. The green interpolation block 102 comprises three similar blocks per line, for example, H1, V1 and G1. The blocks are the same for the separate lines. Again “H” means horizontal and “V” vertical.

The horizontal/vertical interpolation block 104 is configured to receive the signal CDS[1 . . . 3], means signal CDS[1], CDS[2], and CDS[3] and outputs of the blocks G0, G1, G2 of the green interpolation block 102. The horizontal/vertical interpolation block 104 is configured to output signals v_br, h_br to the selector 108 and further signals to the diagonal interpolation block 106.

The diagonal interpolation block 106 comprises blocks NE. (North East), NW. (North West), D and is configured to receive the signals CDS[1 . . . 3] from the horizontal/vertical interpolation block 104 and additional outputs of the blocks G0, G1, G2 of the green interpolation block 102. Further, the diagonal interpolation block 106 is configured to receive a signal from the control block 110. The diagonal interpolation block 106 is further configured to output a d_{D —}br signal.

The selector 108 is configured to receive the signals v_br, h_br, d_br, CDS[2] and an output signal of the block G1 of the green interpolation block 102. The selector 108 is further configured to output the signals R, G, B.

The fraction/range control block 110 is configured to provide a control value or control values to the blocks G0, G1, G2 of the green interpolation block 102 and the block D of the diagonal interpolation block 106. The settings of the fraction/range control block 110 may depend on a mode of the camera, for example, a still mode or a motion mode which may be set by a user of the camera.

The RGB separator is configured to perform a separation method which may comprise four steps.

As a first step which may be performed by the green interpolator 102, missing green values at red or blue pixel locations may be calculated for three consecutive lines. An interpolation may be done horizontally or vertically depending on the highest edge value. According to the invention, in order to achieve, equality an averaging may be done using at least one control. For example two controls, i.e. fraction and range, may be used.

In a further step which may be performed by the horizontal/vertical interpolation block 104, missing red and blue pixels at a current green pixel may be calculated. This may be done by horizontal or vertical interpolation using the green values to boost high frequency response.

In a further step which may be performed by the diagonal interpolation block 106, missing blue and red pixels at respective current red and blue locations may be calculated using diagonal interpolation. An interpolation may be done in Northeast or Northwest direction depending on the highest edge value. According to the invention, in order to achieve equality, an averaging may be done using a control. For example two controls, i.e. fraction and range may be used. The green values will boost high frequency response.

In a further step which may be performed by the selector block 108, correct red, blue or green values may be selected out of the previous interpolations and from the CDS signal controlled by programmable pixel and line identification signals.

FIG. 2 shows a graphic table which describes the selector function which may be executed by the selector block 108.

The first row shows some situations of an array of nine pixels. Eight arrays surround a center pixel. In all situations the three colours R, G and B for a center pixel need to be determined from the nine pixels in the area. Below the four situations it is indicated from which signal the R, G and B colour is generated. If CDS is mentioned it is directly taken from the input. V_br means a vertical interpolation is performed for either red or blue. H_br means the same but then for a horizontal interpolation. D_br means a diagonal interpolation is performed. Diagonal interpolation may either be in NorthEast direction (NE. block in FIG. 1) or in NorthWest direction (NW. block in FIG. 1).

The pixels used to calculate the center pixel colour are taken from the surroundings of the center pixel. Five input lines are used to calculate the signals as shown below. CP indicates the center pixel.

$$\begin{matrix}1 & 2 & 3 & 4 & 5 \\ 6 & 7 & 8 & 9 & 10 \\ 11 & 12 & CP & 13 & 14 \\ 15 & 16 & 17 & 18 & 19 \\ 20 & 21 & 22 & 23 & 24\end{matrix}$$

H_hp is a horizontal high pass filtered signal on pixels 11, CP and 14.

H_sum is the average of the sum of pixels 12 and 13.

H_dif is the difference between pixels 12 and 13.

V_hp is a vertical high pass filtered signal on pixels 3, CP and 22.

V_sum is the average of the sum of pixels 8 and 17.

V_dif is the difference between pixels 8 and 17.

In the following circuits and equations are described which may be used to perform the steps of the separation method.

The first step is directed to the green interpolator.

FIG. 3 shows blocks V1, H1, G1 of the green interpolator 102. The blocks V1, H1, G1 allow green interpolation for one line. Block V1 is a vertical filter block, block H1 is a horizontal filter block and block G1 is an interpolator.

Block V1 is configured to receive signal S[0:4] and to output signals v_hp, v_sum, v_dif. Block H1 is configured to receive signal S[2] and to output signals h_hp, h_sum, h_dif. Block G1 is configured to receive signals v_hp, v_sum, v_dif, h_hp, h_sum, h_dif from the blocks V1, H1 and signals fraction_g, range_g from the control block 110. Block G1 is further configured to output signal green.

The green interpolator is configured to calculate for the three center lines the missing green values at red and blue pixel locations. Also at green pixel locations the interpolation is done, these pixels will be ignored in the successive blocks.

The functions performed in the Blocks V1 and H1 are described in equation 1.

v_{—}hp=(2S[l,px]−S[l−2,px]−S[l+2,px])/2v_sum=(S[l−1,px]+S[l+1,px])/2v_dif=(S[l−1,px]−S[l+1,px])/2 Equation 1

h_{—}hp=(2S[l,px]−S[l,px−2]−S[l,px+2])/2h₁₃ sum=(S[l,px−1]+S[l,px+1])/2h_dif=(S[l,px−1]−S[l,px+1])/2 Equation 2

FIG. 4 shows a block circuit diagram of a block Gn, for example block G1 shown in FIG. 3. The block comprises blocks 420, 421, 422, 423, 424, 425, 426, 427, 428, 429, 430.

Block 420 is configured to receive signals v_hp[n], v_dif[n], to perform the function abs(a)+abs(b) and to output signal verdif.

Block 421 is configured to receive signals h_hp[n], _dif[n], to perform the function abs(a)+abs(b) and to output signal hordif.

Block 422 is configured to receive signals h_sum[n], h_hp[n] and to perform the function a+b.

Block 423 is configured to receive signals v_sum[n], v_hp[n] and to perform the function a+b.

Block 424 is configured to receive signals fraction, range, verdif, hordif, to perform the function f*(a+b)>>4+r<<8 and to output signal maxdif.

Block 425 is configured to receive signals verdif, hordif, to perform the function abs(a−b) and to output signal threshold.

Block 426 is configured to receive signals verdif, hordif and to perform the function a>b.

Block 427 is configured to receive the output signals of block 422 and block 423 and to perform the function a+b+1>>1.

Block 428 is configured to receive the output signals of block 422, block 423 and block 426 and to perform the function mux.

Block 429 is configured to receive signals maxdif, threshold and to perform the function a>=b.

Block 430 is configured to receive the output signals of block 428, block 427 and block 429, to perform the function mux and to output signal green [n].

Blocks 424, 425, 427, 429, 430 are added in accordance with the inventive approach.

The Gn blocks are configured to interpolate missing green pixels depending on the edge information calculated in Hn and Vn

$$\begin{matrix}hordif = \vert h\_hp \vert + \vert h\_dif \vert \\ verdif = \vert v\_hp \vert + \vert v\_dif \vert & Equation 3 \\ green\_old = [ \begin{matrix}h\_sum + h\_hp & if verdif > hordif \\ v\_sum + v\_hp & otherwise\end{matrix} ] & Equation 4\end{matrix}$$

The inventive additions are described in equation 5 and 6.

maxdif=fraction_{—}g·(hordif+verdif)+range_{—}g threshold=|hordif−verdif| Equation 5

The new green interpolation formula becomes as follows:

$$green\_new = [ \begin{matrix}\begin{matrix}v\_sum + h\_sum + \\ h\_hp + v\_hp\end{matrix} & if maxdif \geq threshold \\ green\_old & otherwise\end{matrix} ] \qquad Equation 6$$

The second step of the separation method is directed to the horizontal/vertical interpolator.

If the current pixel is green then blue and red can respectively be interpolated horizontally or vertically. The horizontal/vertical interpolation block 104 provides both interpolations. The selector for separation is located in the later block 108.

h_{—}br=(2S[2,px]+S[2,px−1]+S[2,px−1]−green[1,px−1]-green[1,px+1])/2v_{—}br=(2S[2,px]+S[3,px−1]+S[1,px−1]−green[2,px]−green[0,px])/2 Equation 7

The third step of the separation method is directed to the diagonal interpolator.

FIG. 5 shows a block diagram of the diagonal interpolator block 106. Diagonal interpolation is needed to find red at the current blue pixel or blue at the current red pixel. The diagonal interpolator 106 comprises the blocks NE., NW., D.

Block NE. is configured to receive signals green[0:2], S[1:3] and to output signals ne_hp, ne_sum, ne_dif. Block NW. is configured to receive signals green[0:2], S[1:3] and to output signals nw_hp, nw_sum, nw_dif. Block D is configured to receive signals ne_hp, ne_sum, ne_dif, nw_hp, nw_sum, nw_dif from the blocks NE., NW. and signals fraction_d, range_d from the control block 110. Block D is further configured to output signal d_br.

The diagonal interpolator block 106 is configured to interpolate missing blue/red pixels depending on the edge information calculated in blocks NE. and NW.

The block NE. and the block NW. each provide 3 output signals.

ne_{—}hp=(2green[l,px]−green[0,px−1]−S[2,px+1])/2ne_sum=(S[3,px−1]+S[l,px+1])/2ne_dif=(S[3,px−1]−S[l,px−1])/2 Equation 8

nw_{—}hp=(2green[1,px]−green[0,px+1]−S[2,px−1])/2nw_sum=(S[3,px+1]+S[l,px−1])/2nw_dif=(S[3,px+1]−S[1,px+1])/2 Equation 9

FIG. 6 shows a block circuit diagram of the block D of the diagonal interpolator block 106. The block D is equal to the Gn blocks in the green interpolator 102 and comprises the blocks 420, 421, 422, 423, 424, 425, 426, 427, 428, 429, 430 and additionally block 631.

Block 420 is configured to receive signals nw_hp[n], nw_dif[n], to perform the function abs(a)+abs(b) and to output signal nwdif.

Block 421 is configured to receive signals ne_hp[n], ne_dif[n], to perform the function abs(a)+abs(b) and to output signal nedif.

Block 422 is configured to receive signals ne_sum[n], ne_hp[n] and to perform the function a+b.

Block 423 is configured to receive signals nw_sum[n], nw_hp[n] and to perform the function a+b.

Block 424 is configured to receive signals fraction_d, range_d, nwdif, nedif, to perform the function f*(a+b)>>4+r<<8 and to output signal maxdif.

Block 425 is configured to receive signals nwdif, nedif, to perform the function abs(a−b) and to output signal threshold.

Block 426 is configured to receive signals nwdif, nedif and to perform the function a<b.

Block 427 is configured to receive the output signals of block 422 and block 423 and to perform the function (a+b)/2.

Block 428 is configured to receive the output signals of block 422, block 423 and block 426, to perform the function mux and to output signal d_br_old.

Block 429 is configured to receive signals maxdif, threshold and to perform the function a>=b.

Block 430 is configured to receive the output signals of block 428, block 427 and block 429 and to perform the function mux.

Block 631 is configured to receive the output signal of block 430, to perform the function limit to 15 bits and to output signal d_br_new.

Block D as shown in FIG. 6 may be configured to perform the following equations.

$$\begin{matrix}nwdif = \vert nw\_hp \vert + \vert nw\_dif \vert \\ nedif = \vert ne\_hp \vert + \vert ne\_dif \vert & Equation 10 \\ d\_br \_old = [ \begin{matrix}nw\_sum + nw\_hp & if nedif > nwdif \\ ne\_sum + ne\_hp & otherwise\end{matrix} ] & Equation 11\end{matrix}$$

The inventive additions are described in equations 12 and 13:

maxdif=fraction_d·(nwdif+nedif)+range_{—}d threshold=|nwdif−nedif| Equation 12

The new green interpolation formula becomes:

$$d\_br \_new = [ \begin{matrix}\begin{matrix}nw\_sum + ne\_sum + \\ nw\_hp + ne\_hp\end{matrix} & if maxdif \geq threshold \\ d\_br \_old & otherwise\end{matrix} ] \qquad Equation 13$$

The fourth step is directed to a switch. The switch function is configured to simply select the correct interpolator type for the three output streams R, G and B depending on the colour filter of the current pixel.

FIG. 7 shows a 2D spectrum of the inventive separator output of a zoneplate input. In grey is the full spectrum that can be relaxed orthogonally using range control and diagonally using fraction control.

Arrows 731 indicate the range control and arrows 732 indicate the fraction control.

By adding the controls fraction and range the full spectrum of the separator can be controlled. The range control lowers the orthogonal resolution and the fraction lowers the diagonal resolution.

A slight decrease of about 5% resolution may already improve the brick artefact significantly.

The described steps of the inventive method may be performed in combination, in different order or alone. Using the method is not limited to the field of digital cameras. The described equations and circuit blocks may be replaced by similar ones without leaving the scope of the invention.

### REFERENCE SIGNS

102 green interpolation block
104 horizontal/vertical interpolation block
106 diagonal interpolation block
108 selector
110 fraction/range control block
420, 421, 422, 423, 424, 425, 426, 427, 428, 429, 430 circuit blocks
631 circuit block
731 range control
732 fraction control

1. Method suitable for processing colour values provided by a camera sensor comprising pixels of different colours, characterized in that 15 values of a first colour at positions of pixels of a second and a third colour are interpolated (102) based on an averaging using at least one control value.

2. Method according to claim 1, characterized in that the at least one control value comprises a fraction and/or a range control value (110).

3. Method according to claim 1, characterized in that the method comprises a still mode and a motion mode, wherein the values of the first colour are interpolated based on the averaging in the motion mode and wherein different values of the first colour are interpolated without the averaging in the still mode.

4. Method according to claim 1, characterized in that the values of the first colour are interpolated based on the equations of the form
$$green\_new = [ \begin{matrix}\begin{matrix}v\_sum + h\_sum + \\ h\_hp + v\_hp\end{matrix} & if maxdif \geq threshold \\ green\_old & otherwise\end{matrix} ]$$
$$maxdif = fraction\_g \cdot ( hordif + verdif ) + range\_g$$
$$threshold = \vert hordif - verdif \vert$$
$$h\_hp = ( 2 S [ l , px ] - S [ l , px - 2 ] - S [ l , px + 2 ] ) / 2$$
$$h\_sum = ( S [ l , px - 1 ] + S [ l , px + 1 ] ) / 2$$
$$h\_dif = ( S [ l , px - 1 ] - S [ l , px + 1 ] ) / 2$$
$$v\_hp = ( 2 S [ l , px ] - S [ l - 2 , px ] - S [ l + 2 , px ] ) / 2$$
$$v\_sum = ( S [ l - 1 , px ] + S [ l + 1 , px ] ) / 2$$
$$v\_dif = ( S [ l - 1 , px ] - S [ l + 1 , px ] ) / 2$$
wherein
green_new: value of the first colour
fraction_g: fraction control
range_g: range control
S[a,b]: value of a pixel at position [a,b]
S[l,px]: value of a center pixel.

5. Method according to claim 3, characterized in that the different values of the first colour are interpolated in still mode based on equations of the form
$$green\_old = [ \begin{matrix}h\_sum + h\_hp & if verdif > hordif \\ v\_sum + v\_hp & otherwise\end{matrix} ]$$
$$hordif = \vert h\_hp \vert + \vert h\_dif \vert$$
$$verdif = \vert v\_hp \vert + \vert v\_dif \vert$$
$$h\_hp = ( 2 S [ l , px ] - S [ l , px - 2 ] - S [ l , px + 2 ] ) / 2$$
$$h\_sum = ( S [ l , px - 1 ] + S [ l , px + 1 ] ) / 2$$
$$h\_dif = ( S [ l , px - 1 ] - S [ l , px + 1 ] ) / 2$$
$$v\_hp = ( 2 S [ l , px ] - S [ l - 2 , px ] - S [ l + 2 , px ] ) / 2$$
$$v\_sum = ( S [ l - 1 , px ] + S [ l + 1 , px ] ) / 2$$
$$v\_dif = ( S [ l - 1 , px ] - S [ l + 1 , px ] ) / 2$$
wherein
green_old: different value of the first colour
S[a,b]: value of a pixel at position [a,b]
S[l,px]: value of a center pixel

6. Method according to claim 1, characterized in that values of the second and third colour at a position of a pixel of the first colour are obtained by a horizontal or vertical interpolation (104) using the values of the first colour.

7. Method according to claim 1, characterized in that values of the second colour at positions of pixels of the third colour and values of the third colour at positions of pixels of the second colour are interpolated (106) based on the averaging.

8. Method according to claim 1, characterized in that correct values of the first, second and third colour are selected (108) from interpolated values and from values provided by the camera sensor.

9. Apparatus for performing all steps of a method according to claim 1.

10. Computer program comprising program code means for performing all steps of a method according to claim 1, when the computer program is executed on a computer or a corresponding processing unit.

11. Computer program product comprising program code means stored on a computer readable data carrier, for performing all steps of a method according to claim 1, when the computer program is executed on a computer or a corresponding processing unit.
